(19) United States
(12) Patent Application Publication
(10) Pub. No.: US 2020/0151781 A1
(43) Pub. Date: May 14, 2020

(54) SYSTEM AND METHOD FOR REDEEMING VIRTUAL CURRENCY/POINTS FOR TANGIBLE GOODS AND/OR SERVICES

(71) Applicants: Andrew Pascal, Las Vegas, NV (US); Paul Mathews, Las Vegas, NV (US)

(72) Inventors: Andrew Pascal, Las Vegas, NV (US); Paul Mathews, Las Vegas, NV (US)

(21) Appl. No.: 13/472,454

(22) Filed: May 15, 2012

Related U.S. Application Data
(60) Provisional application No. 61/486,527, filed on May 16, 2011.
(60) Provisional application No. 61/598,767, filed on Feb. 14, 2012.

(51) Int. Cl. G06Q 30/06; A63F 13/55

(52) U.S. Cl. CPC G06Q 30/0601; A63F 13/55

(57) ABSTRACT

A method, apparatus, and computer readable storage to implement a social networking game that allows player to earn credits and loyalty points based on actions taken in the game. Only if the player meets certain predetermined conditions, then the player would be allowed to redeem some or all of the credits or loyalty points for tangible goods and/or services which can then be delivered to the player. If the player does not meet the predetermined conditions, then the player would not be allowed to redeem points for tangible goods and/or services.

### CROSS REFERENCE TO RELATED APPLICATIONS

This Application claims benefit of U.S. provisional application 61/486,527, filed on May 16, 2011, entitled, “System and Method for Redeeming Virtual Currency/Points for Tangible Goods and/or Services” which is incorporated by reference herein in its entirety. This Application also claims benefit to U.S. provisional application 61/598,767, filed on Feb. 14, 2012, entitled, “Social Networking Game with Non-Random Prizes” which is incorporated by reference herein in its entirety.

### BACKGROUND OF THE INVENTION

### Field of the Invention

The present general inventive concept is directed to a method, apparatus, and computer readable storage medium directed to a game that can be played on social networking sites, whether accessed via the internet or through mobile devices/channels, that provides players opportunities to redeem credits (or points or other player quantity) for tangible foods and/or services.

### Description of the Related Art

Virtual currency and/or points may be earned on many online websites including social networking websites offering games. With many such games, players earn virtual currency by playing the games and which may be redeemed for virtual goods. Users purchase virtual goods to increase their prominence and notoriety on the website. That is, the more virtual goods a user accumulates, the more significant the user is within the website community playing the game. While the use of virtual currency online is meaningful, redemption options remain limited.

Accordingly, it would be beneficial to provide a system and method for facilitating the redemption of credits (or points) for tangible goods and/or services.

### SUMMARY OF THE INVENTION

It is an aspect of the present invention to provide a system and method that allows players to redeem their credits (or points) for tangible goods and/or services.

The above aspects can be obtained by a method that includes (a) executing on an electronic processing unit, instructions to perform: (b) maintaining an amount of points earned by a player in a player's account, the points earned by playing a game; (c) determining whether the player meets one or more conditions to be eligible to convert points into tangible products, wherein the determining determines that the player is eligible; (d) receiving confirmation by the player to convert an amount of points representing a cost of a selected tangible item; (e) deducting the cost of the selected tangible item from the player's account; and (f) delivering the tangible item to the player.

The above aspects can be obtained by an apparatus that includes (a) a network connection; (b) a server connected to the network connection, the server configured to perform: (c) maintain an amount of points earned by a player in a player's account, the points earned by playing a game; (d) determine whether the player meets one or more conditions to be eligible to convert points into tangible products; (e) only when the play meets the one or more conditions, then: f) receive confirmation by the player to convert an amount of points representing a cost of a selected tangible item; g) deduct the cost of the selected tangible item from the player's account; and h) initiate a delivery of the tangible item to the player.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a drawing illustrating numerous apparatuses that can play the game described herein, according to an embodiment;

FIG. 2 is a flowchart illustrating an exemplary method of converting loyalty points into sweepstakes entries, according to an embodiment;

FIG. 3 is a flowchart illustrating an exemplary method of adjusting game-play based on a player's loyalty points, according to an embodiment;

FIG. 4 is a flowchart illustrating an exemplary method of awarding a predetermined prize on a game, according to an embodiment;

FIG. 5 is a block diagram illustrating exemplary hardware that can be used to implement the game described herein, according to an embodiment;

FIG. 6 is a network diagram showing a network structure for a social networking web site and players, according to an embodiment;

FIG. 7 is a block diagram illustrating another network structure, according to an embodiment;

FIG. 8 is a block diagram of a system architecture of a website, according to an embodiment;

FIG. 9 is a block diagram of a redemption engine, according to an embodiment;

FIG. 10 is a flowchart illustrating an exemplary method of implementing a redemption engine, according to an embodiment;

FIG. 11 is a drawing of a first web page illustrating redemption of credits, according to an embodiment;

FIG. 12 is a drawing of a second web page illustrating redemption of credits, according to an embodiment; and

FIG. 13 is another block diagram of a system architecture of a website, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a game that can be played on a social networking site such as FACEBOOK (including what is described in U.S. Pat. No. 7,669,123 which is incorporated by reference herein in its entirety), MYSPACE, or any other site which maintains a database of users and provides an interface for interaction. The game can provide a player with an opportunity to play a game such as slot machine type games, casino games, and other types of games.

There are two types of point values that each player on a gaming site (which can exist as an independent site or an application played on a social networking platform such as FACEBOOK or other delivery mechanism) can possess: credits and loyalty points.

Credits (also referred to as non-cash value credits, non-cash value chips, NCV credits, NCV chips) are used to play each instance of a wagering game but cannot be directly exchanged for cash. For example, a slot game may require a payment of 100 credits in order to spin the slot machine, and if the player wins then the player is awarded in credits. A player can place a “wager” of 50 credits (or $50 in non-cash value chips) on a hand in a virtual blackjack game wherein depending on the outcome, the player would lose the wager or win an award in a same form of the initial “wager” (e.g., the player would win 50 credits or win 50 non-cash value chips). The word “wager” is embedded in quotes because these are not wagers for real money, in that if the player wins, he wins more credits but the credits are not exchangeable for cash (this could run afoul of online gambling laws). Players may be given credits for free (e.g., each player gets 10 free credits each day or week), or players may be given the opportunity to purchase credits for real money (cash). Credits can be purchased using a payment processor which can accept payment via a credit card, PAYPAL account, etc.

Loyalty points (also referred to as loyalty currency) are points that players can earn by their activity on and related to the site. In general, loyalty points are a measure of the value of a player to the site (the more points a player has means the player is more valuable to the site). Examples of ways loyalty points can be earned by a player include: 1) Referring friends to the site (the player can identify a friend to the site (either their email address or clicking their name) and if this friend signs up with the site, this can be considered a referral). Or, a referral can be considered an initial referral from a player to his friend(s) regardless of whether those friends actually sign up with the site. A player can receive a predetermined amount of points per referral (e.g., 20 loyalty points per referral), or a player can receive a predetermined amount of loyalty points per a number of referrals (e.g., when a player refers 10 friends the player gets 100 loyalty points). 2) As an add-on to earning loyalty points based on a number of friends referred, loyalty points can also be determined based on the “quality” (or “value”) of those friends. For example, if player's referred friends have a good average “quality” (they play on the site a lot, refer others, spend cash on the site, etc.) then the player would earn more loyalty points because the quality/value of this player's referrals are good. This can be quantified by taking an average of loyalty points of a player's friends and awarding the player this average in additional loyalty points (the average can optionally be multiplied by a constant or other variable). In other words, the quality of a player's referrals can be measured by each of their respective number of loyalty points, and this quality can be used in order to help the player earn additional loyalty points. Of course the better quality of a player's referrals the more additional loyalty points the player will earn, while a worse qualify of a player's referrals the less additional loyalty points the player will earn. The quality (also referred to as value in this context) of a player's referrals can be measured using other mechanisms besides loyalty points, for example, summing the number of referrals of each of the player's referrals; summing a total of cash purchases of the player's referrals, or quantifying any other factor described herein that would measure the quality/value of a player's referrals. For example, Joe referred ten friends who on the average referred two friends each (for a total of 20 new referrals), and Bob referred 3 friends who on the average referred 10 friends each (for a total of 30 new referrals), Bob (if the metric were simply the number of referrals of referrals) would be more valuable to the site than Joe (and in an embodiment Bob would be awarded more loyalty points (e.g., 30 points) than Joe (20 points) if loyalty points were solely measured on referrals of referrals). In a further embodiment, loyalty points can be based on (or incorporate) a player's total derivative referrals (e.g., referrals, referrals of those referrals, and so on). “Derivate referrals” refers to every player who is referred to the site that would not be registered users of the site (assuming they would not have found the site independently) but for the player's entire network of referrals (e.g., Bob's derivative referrals are all of Bob's referrals plus all of Bob's referral's referrals plus all of Bob's referral's referral's referrals, and so on).

Similar to referrals, “derivative cash” is total cash spent on the site by a player's derivative referrals. For example, if all of Joe's derivative referrals spend a total of $2,300 (Joe's derivative cash) in cash on the site, and all of Bob's derivative referrals spend a total of $1,000 (Bob's derivative cash) on the site, then Joe could be considered to have more value to the site than Joe. Loyalty points can be based (or incorporate) a player's derivative cash. In an embodiment, a player can receive loyalty points based on a percentage (e.g., 1%) of that player's derivative cash.

Further ways loyalty points can be earned are: 3) Spending at least a predetermined minimum of time playing games on the site (e.g., if a player spends 50 hours (does not need to be consecutive) playing games (or a particular game) on the site, the player would receive 100 loyalty points). 4) Achieving a particular outcome in a game on the site (e.g., if a player completes a particular level of a hidden object game, the player will earn 25 loyalty points). 5) Purchasing a product advertised on the site (and purchasing it through the site) would earn the player loyalty points, e.g., if a book is advertised on the site and the player purchases the book (clicking the link on the site) using cash, the player can earn 5 loyalty points (or the loyalty points earned can be a percentage of the price of the book, e.g., the player can earn 5% of a purchase price in loyalty points so that buying a book costing $50 will earn the player 2.5 loyalty points).

A player is permitted to purchase credits (e.g., $10 cash for 100 credits) but the player typically would not be permitted to directly purchase loyalty points. In an embodiment, the player would be allowed to convert loyalty points into credits (e.g., 10 loyalty points can be converted into 2 credits) but the player would not be allowed to convert credits into loyalty points (this would effectively be allowing the player to purchase loyalty points which is typically not permitted).

Loyalty points can be used (paid) by the player (to the site) in order to redeem incentives (from the site). Loyalty points can be redeemed in the following ways: 1) Loyalty points can be used for entries into a lottery or sweepstakes or raffle type of game, e.g., each loyalty point can be exchanged for one entry in the lottery/sweepstakes (which can award cash or other valuable prizes), so for example 100 loyalty points would be exchanged for 100 entries into the lottery/sweepstakes. The lottery/sweepstakes can pick a number of random entries out of all of the entries entered into the lottery/sweepstakes to be awarded prize(s). 2) Loyalty points can be directly exchanged for cash or valuable prizes (e.g., 1000 loyalty points can be exchanged for a particular model of digital camera). 3) Loyalty points can be exchanged into credits (e.g., 2 loyalty points can be exchanged for 1 credit). 4) Loyalty points can be used to purchase certain advantages on the site. For example, 100 loyalty points could buy an advantage on the game (e.g., in a dungeons and dragons type of game, an advantage could be a more powerful weapon). 5) Loyalty points can be used to unlock particular levels, e.g., a particular level on a game (e.g., a location on a hidden object game) is not freely available to players unless the player unlocks that level by paying a predetermined number of loyalty points.

One example of a “master formula” for determining a number of loyalty points awarded to a player can be as follows:

Loyalty points=(2*N+4*S+P*7+C*2+Q*4)/19.

wherein N=number of friends referred, S=number of those friends that have actually registered with the site, P=amount of cash purchases made by the player, H=number of hours the player has played on the site, C=number of links on the site the player has clicked, Q=average number of loyalty points of the friends referred that have registered with the site. This is of course just one example, and any other formula can be used to determine loyalty points. In an embodiment, instead of a composite value for loyalty points (as described above), different values (types) of loyalty points can be maintained for each player (e.g., one value of loyalty points based on the player's friends, another value of loyalty points based on the player's activity) and these can be used in any manner described herein. A loyalty point amount can be computed from only one factor up (e.g., solely based on a number of friends referred) to a composite of any number of factors (including any combination of factors discussed herein or others not discussed).

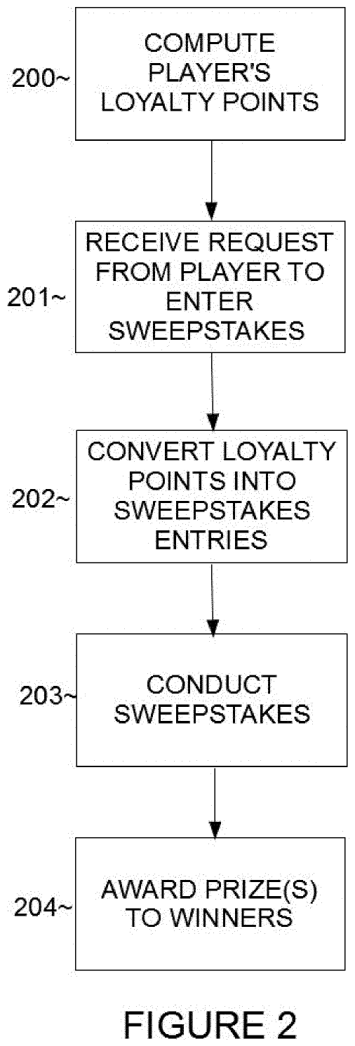

FIG. 2 is a flowchart illustrating an exemplary method of converting loyalty points into sweepstakes entries, according to an embodiment. This method (and all methods described herein) can be performed on a server associated with the site (which can be working in communication with the social network site which would typically be controlled by a different server).

In operation 200, the number of loyalty points for a player is computed. This can be done each time the amount of loyalty points is needed (since the player's history and all of the data needed to computer the loyalty points is all stored). Alternatively, the amount of loyalty points can be computed on a “rolling” basis, that is, a running total is kept and each action that occurs that would earn the player additional loyalty points (e.g., the player has referred a friend), this would add a respective number of loyalty points to the player's total number of loyalty points.

From operation, the method proceeds to operation 201, which receives a request from the player to enter the sweepstakes. Note the order of operations 200 and 201 can also be reversed. The player can make this request for example by using a graphical user interface (GUI) and click respective icons (or type respective text) as needed to indicate the players desire to enter a sweepstakes using the player's loyalty points. The player would typically be presented with the player's amount of loyalty points and the player can optionally be prompted to enter how many of the player's loyalty points does the player wish to convert to sweepstakes entries (e.g., if the player has 1,000 loyalty points the player may wish to only use 500 of those points for entries into the Sweepstakes).

From operation 201, the method proceeds to operation 202, which converts the loyalty points into sweepstakes entries. There can be a conversation ratio (e.g., ten loyalty points equals one sweepstakes entry) or there can be a ratio of 1 (one loyalty point equals one sweepstakes entry). Of course the player's total number of loyalty points is deducted by the amount of points converted into entries. When points are converted into entries, each entry can be stored in a database (or record) on a server so that each player's entries are recorded and that the total number of entries is easily tabulated and maintained.

From operation 202, the method proceeds to operation 203, which conducts the sweepstakes. The sweepstakes can pool all of the entries from players (it does not matter how those entries were earned, e.g., some may have been converted upon request of players and other players may have been the entries in games) into a single pool and a predetermined number (the number of winners) of entries are randomly picked from the pool. Different picks could have different prizes associated with them (e.g., the first ten picks will win $50 cash and the eleventh pick will win a new car). Each entry in the Sweepstakes would typically have an equal chance of being picked. This type of sweepstakes can also be considered a raffle game.

From operation 203, the method proceeds to operation 204, which awards the prizes to their respective winners. The winners can be informed as such via an instant message, email message, etc. Physical prizes can be mailed to the player's home and intangible prizes (e.g., cash, gift certificates, etc.) can be delivered electronically to the player.

Loyalty points can also be used in two ways, depending upon the embodiment being implemented. In one embodiment, loyalty points can be a discrete quantity possessed by a player (similar to the player's number of credits) and the number of loyalty points can be “spent” on various items (entering into lottery/sweepstakes games, used for purchasing prizes, etc. in which the spent amount of loyalty points is deducted from the player's total loyalty points) In another embodiment, a player's number of loyalty points is used more for internal purposes in order provide the player advantages to games based on the player's number of loyalty points. In this embodiment, players may be given “grades” based on their respective number of loyalty points. For example, a table such as Table I below can be used to determine a player's grade (also referred to as category). In this embodiment, typically the player's loyalty points do not decrease (are not “spent”) when it is used for advantages/incentives/prizes, although some conditions can trigger a decrease (e.g., if the player is inactive for a predetermined period of time (e.g., six months) the player would lose half of his/her loyalty points.

TABLE I

| Loyalty points | category |
|---|---|
| <100 | novice |
| 100-400 | member |
| 400-1000 | preferred member |
| >1000 | VIP |

Thus, a player who has 150 loyalty points would be considered a “member.” Players can receive additional advantages in games based on their category. Different games can have different advantages based on their category. For example, in a dungeons and dragons type of game, a player's shield strength can be 10 for a novice, 50 for a member, 100 for a preferred member, and 150 for a VIP. In another embodiment, discrete categories are not necessary and players can be given their advantages based on their number of loyalty points (e.g., a player's shield strength in a dungeons and dragons type of game is equal to 10 plus the number of loyalty points the player has).

Other ways a player's number of loyalty points can be used is as follows. In a poker game, a player with more loyalty points can be given better cards (e.g., more likely to get an ace). In a poker game, a player with more (or at least a predetermined number of) loyalty points can be given (occasionally or always) the opportunity to view some (or all) of his/her opponents cards (which during standard poker (and if the player did not have the required number of loyalty points) the player would not be permitted to see). In a blackjack game, a player with more (or at least a predetermined number of) loyalty points can be given advantages, such as the player wins on ties (instead of pushing). In a slot game, if a player has more (or at least a predetermined number of) loyalty points the player would be more likely to receive a wild symbol when the reels stop spinning. Or in a slot game, if a player has more (or at least a predetermined number of) loyalty points the player would receive bigger awards (an improved paytable). Or in a slot game, if a player has more (or at least a predetermined number of) loyalty points, he would qualify for different reel mappings (some more favorable than others). For example, each of the categories in Table I can have associated with it a different reel mapping (the higher the category, the more favorable to the player), and when player plays a particular slot machine that machine would use its respective reel mapping (typically the player would not be aware of the different reel mappings). Along the same lines, each category can have associated with it its own paytable (some more favorable than others), and the respective paytable is used when the slot game is played (e.g., a royal flush on a video poker game for the novice category would pay the standard 250, a royal flush for the member category would pay 300, a royal flush for the preferred member category would pay 500, and a royal flush for the VIP would pay 1000, assuming all categories otherwise use a standard paytable (e.g., jacks or better—1/two pair—2/three of a kind—3/straight—4/flush—6/full house—9/four of a kind 25/straight flush—50/royal flush—250).

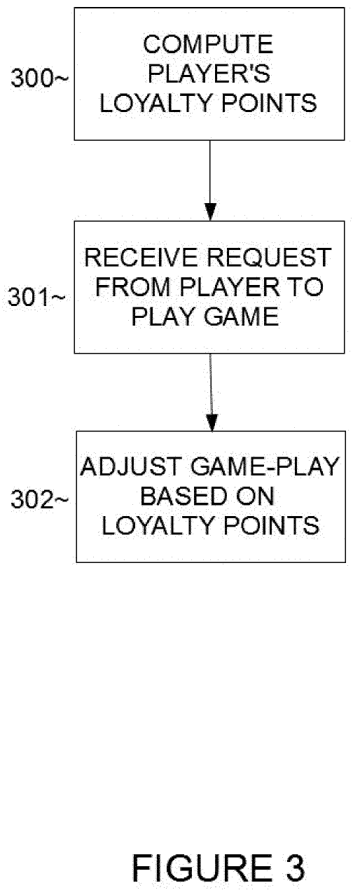

FIG. 3 is a flowchart illustrating an exemplary method of adjusting game-play based on a player's loyalty points, according to an embodiment.

In operation 300, the player's loyalty points are computed. See operation 200 (and the entire application) for more on how this can be accomplished.

From operation 300, the method proceeds to operation 301, wherein a player's request to initiate (play) a particular game is received. This can be done as known in the art, for example the player can use a GUI to click a particular slot machine (or other game) the player wishes to play.

From operation 301, the method proceeds to operation 302, which adjusts the game-play based on the player's loyalty points. This can be done as described herein. For example, based on the player's loyalty points, the player can be given a different reel mapping (for a slot game), a different paytable (for a slot game, video poker game, or any other game that uses a paytable), can provide the player advantages (e.g., a stronger character in a dungeons and dragons or fighting game, etc.) or any other adjustment to any game that would be in the player's interest when the player qualifies by having at least a predetermined number of loyalty points. Another advantage the player can receive is the player can be more likely to receive higher value symbols (e.g., a wild symbol or other symbols that are favorable to the player) with a higher number of loyalty points. For example, a novice player (from Table I) may receive a wild symbol on a slot game (or a joker card in a video poker game) one out of every 10 games, while a preferred member (from Table I) may receive a wild symbol on a slot game (or a joker card in a video poker game) one out of every 5 games.

Casino games on a casual gaming web site typically cannot allow players to play for real money (cash). Valuable prizes can be awarded to players but valuable prizes typically cannot be awarded based on outcomes of games (which can be played by the payment of credits) because this would be tantamount to gambling (since credits can be purchased with money and are used to play games). However, indirect mechanisms can be used in order to award players valuable prizes without their award being directly dependent upon an outcome of a random game.

In an embodiment, valuable awards can be awarded to the player but valuable awards cannot be awarded based on random results which are triggered by a payment of credits (because this may be tantamount to gambling). However, valuable awards can be awarded based on a determination that is independent of the game that is currently being played by the player. For example, a player who has more than a predetermined number of loyalty points would be predetermined to win a prize (e.g., a $5 coupon for AMAZON.COM). When the player goes to play a slot machine type game on the site, the reels on the slot machine would stop on a combination that would award the player the $5 coupon (or any other valuable prize). The player may not realize that this result was “pre-determined” as the spin of the slot game would appear to the player as if it was any other spin. A table (such as Table II below) can map levels of loyalty points to valuable prizes. When a player is awarded the valuable prize, either the respective number of loyalty points is deducted from the player's number of loyalty points or that valuable prize is just removed from the prizes that will be awarded to the player based on this paradigm (but there is no deduction).

TABLE II

| Loyalty points | Prize |
|---|---|
| 100 | $5 coupon for AMAZON.com |
| 500 | $20 cash |
| 5,000 | digital camera model 123 |
| 25,000 | Bahamas vacation |

Thus, for example, in Table II, when a player earns 100 loyalty points, the next time he plays a slot machine game on the site (or a particular slot machine game) the reels will stop on a combination that awards a $5 coupon for AMAZON. The player would continue to earn loyalty points (the 100 points would not be deducted although in another embodiment it can be) and when the player earns 500 loyalty points and players the slot machine game on the site the reels will stop on a combination that awards $20 cash to the player. The player may (or may not) know that these prizes are “predetermined.” Table III represents a paytable that can be used with this embodiment which awards particular prizes from Table II (and others). Each spin of this slot machine game may cost 50 credits (or any other number).

TABLE III

| Combination | Award |
|---|---|
| 7-7-7 | 10,000 credits |
| airplane/airplane/airplane | Bahamas vacation |
| bar/bar/bar | 1,000 credits |
| orange/orange/orange | 25 credits |
| camera/camera/camera | digital camera |
| any two 7's | $20 cash |
| any one 7 | $5 coupon for AMAZON |

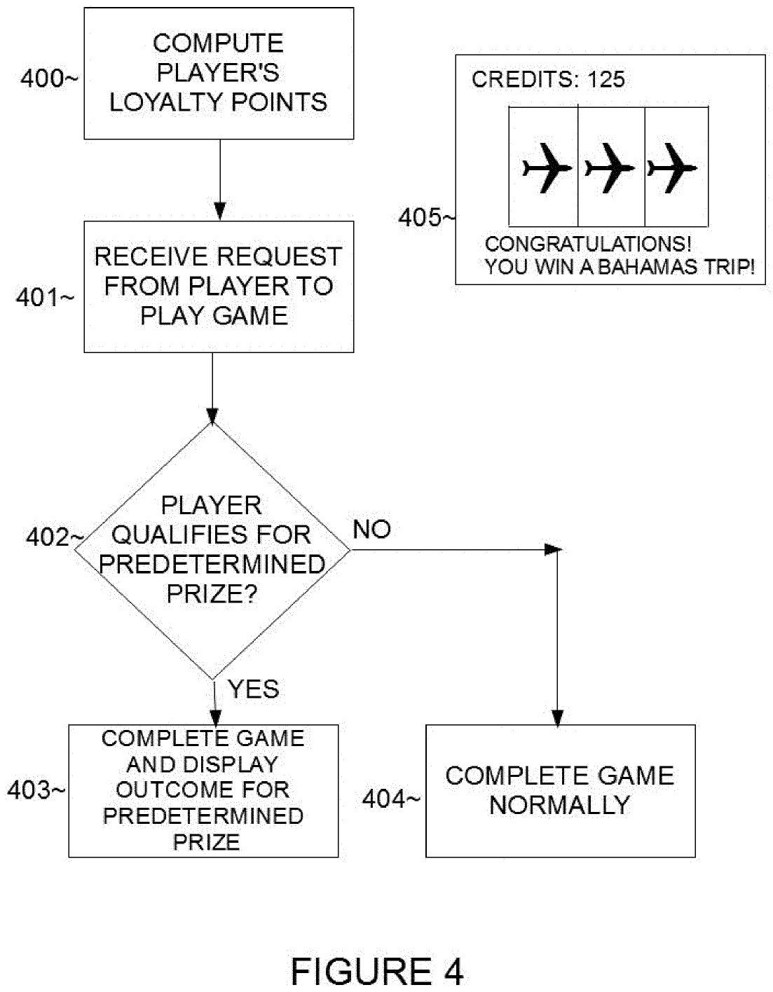

FIG. 4 is a flowchart illustrating an exemplary method of awarding a predetermined prize on a game, according to an embodiment.

In operation 400, the player's loyalty points are computed. See operation 200 and the entire description herein for more detail on this. This is not a requirement for this method if the award of the predetermined prize (in operation 402) does not use the amount of loyalty points.

From operation 400, the method can proceed to operation 401, which receives a request from a player to play a particular game (e.g., a slot game, video poker game, casino table game, etc.)

From operation 401, the method proceeds to operation 402, which determines whether the player qualifies for a predetermined prize (if the player does not satisfy the stated condition then the player would not qualify). This determination can be performed in numerous ways. In one embodiment, if the player has at least a predetermined amount of loyalty points, then the player would be entitled to a predetermined prize.

In another embodiment, the player's loyalty points do not have to be used in order to make the determination of whether the player qualifies for a predetermined prize. In an embodiment, if the player has completed a predetermined activity (e.g., received at least a particular score on a game or completed a certain level), the player could qualify for the predetermined prize. In another embodiment, if the player has taken an action such as logging into the site (or playing a particular game) at a particular time, the player would qualify for a predetermined prize. In another embodiment, if the player's name meets a predetermined condition (e.g., the player's initials are two randomly picked letters) and the player logs into the site (or players the game) during a particular time range, the player would qualify for the predetermined prize. In another embodiment, if the player referred at least a particular number of friends then the player would qualify for the predetermined prize (this is equivalent to having loyalty points determined solely on the number of friends the player has referred and using the loyalty points as the qualifying condition as discussed above).

If in operation 402, the player did meet the stated condition (criteria) to qualify for the predetermined prize (award), then the method proceeds to operation 403, wherein the game games is completed and the outcome displayed is not really random but is “reverse mapped” based on the predetermined prize awarded. For example, if the player is to earn a Bahamas vacation (from Table II) on a slot game, then the outcome the slot game will display the symbols on the final result as airplane/airplane/airplane (see Table III). The symbols would spin and the player would typically not know that this prize was predetermined to be awarded to the player (thus in this case the reels do not stop at random outcomes). Sample slot output 405 illustrates a slot game window where the player received this outcome.

If in operation 402, the player did not meet the stated condition (criteria) to qualify for the predetermined prize (award), then the method proceeds to operation 404, wherein the game proceeds and is completed normally (for example, if the game is a slot type game, then the reels stop at random positions an award, if earned, is awarded based on the final symbol combination). It is noted that even though the player did not qualify for a predetermined award, the player can still win any of the prizes on the paytable if the player coincidentally receives that outcome. For example, if the player is lucky enough to receive three airplanes, then the player can still win the Bahamas trip.

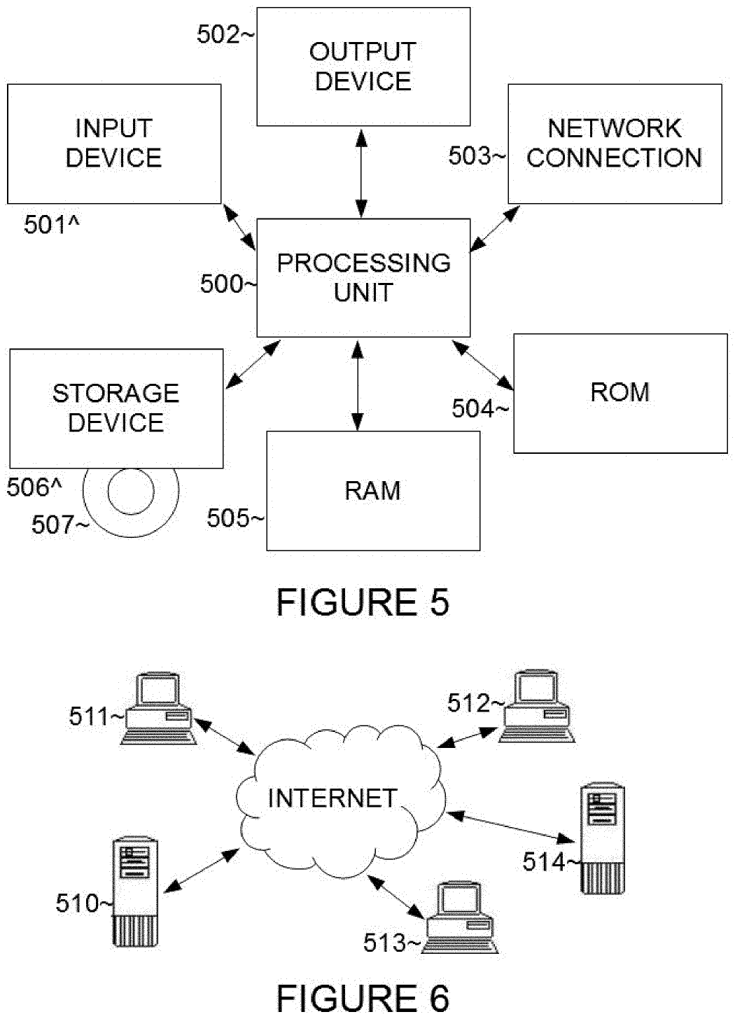

FIG. 5 is a block diagram illustrating exemplary hardware that can be used to implement the game described herein, according to an embodiment. The hardware in FIG. 5A can be used to implement a computer implementing the game described herein and/or a server that is serving the game to a computer which is displaying the game to a player. Such a server can interface with a social networking site (e.g., FACEBOOK, MYSPACE, etc.) that is used to coordinate the entire game and communicate with the players as well as a server used by the social network site.

A processing unit 500 can be a microprocessor and associated structure (e.g., bus, cache, clock, etc.) which can be connected to an input device (e.g., touch-screen, keyboard, mouse, buttons, etc.), and an output device (e.g., touch-screen, CRT, monitor, etc.) The processing unit 500 can also be connected to a network connection 503 which can connect to a computer communications network such as the Internet, Wi-Fi, LAN, WAN, etc. The processing unit 500 can also be connected to a ROM 504 and a RAM 505 as used in the art. The processing unit 500 can also be connected to a storage device 506 which can be nonvolatile storage device (e.g., BLU-RAY drive, CD-ROM drive, hard drive, EPROM, etc.) A computer readable medium 507 (e.g., BLU-RAY disc, CD-ROM, hard disc, etc.) can be read by the storage device 506 and can store programs and assets that can cause the processing unit 500 to perform any of the methods described herein. The ROM and RAM can also be loaded with instructions that can cause the processing unit 500 to perform any of the methods described herein.

FIG. 6 is a network diagram showing a network structure for a social networking web site and players, according to an embodiment.

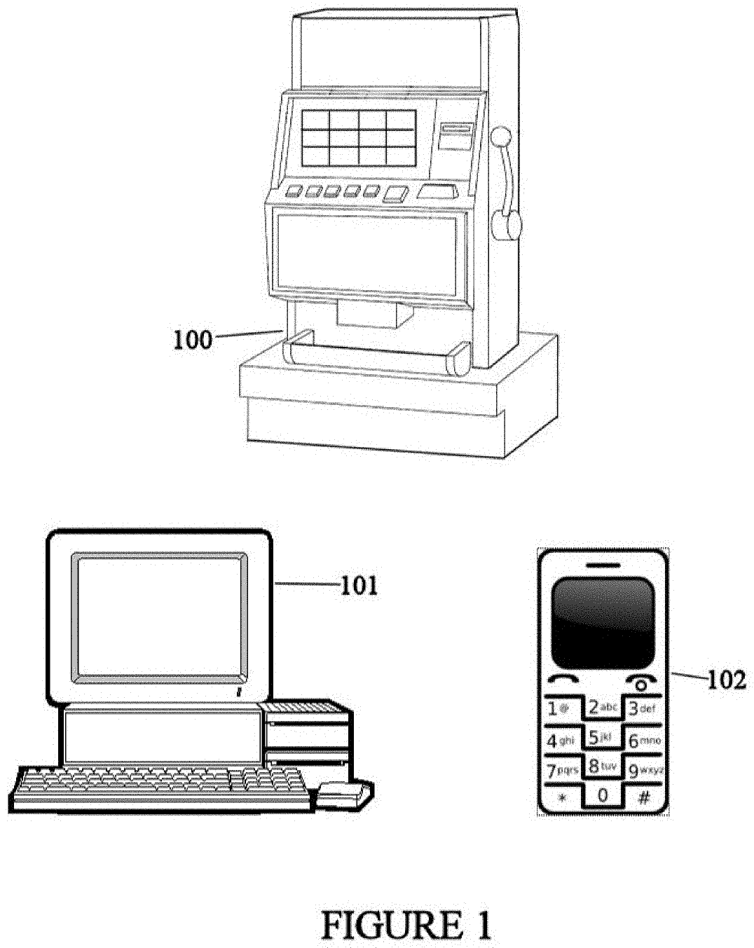

A computer communications network (such as the Internet) can be used to connect a host server 510 which can host and serve a social networking site. Note that while FIG. 5B shows only one server as the host server 510, the host server 510 can encompass numerous servers all cooperating with each other (whether in the same physical location or not). The host server 510 communicates with players 511, 512, 513 through the Internet (or other computer communication network) and can implement any of the methods herein by executing computer code programmed accordingly. Game server 514 can also implement all games and methods described herein on the site by executing computer code programmed accordingly. The game server 514 is connected to the Internet and can communicate with all of the players 511, 512, 513 directly or indirectly through the social networking site hosted by the host server 510. The game server 514 can cooperate with the host server 510 so that the games run on the game server 514 can be integrated into the social networking site hosted by the host server 510. The game server can also be optional and all of the games can be also hosted on the host server 510, whereby the integration of the games served/hosted by the game server 514 will appear embedded in the social networking site hosted by the host server 510 such that players would typically not realize (or care) that multiple servers are cooperating in order to play games on the social networking site. All of the communications described herein can be effectuated using such a network configuration. Typically, the communications are effectuated on the social networking site itself, thus the players 511, 512, 513 should be logged into the social networking site in order to participate herein, although logging in is not required (e.g., communications can be transmitted using other methods, such as email, IRC chat, instant message, etc.) The host server 510 can communicate with any of the devices illustrated in FIG. 1.

All components herein can be distributed across different such components as needed. For example, a single server as mentioned herein can be distributed across numerous different servers and locations. A processor (or processing unit) can also be distributed across multiple processors in a same or different computer (at a same or different location). The electronic components described herein represent an abstraction but it can be appreciated that the computer systems implementing the methods herein can be more numerous and interconnected than illustrated herein.

If a player is playing the game described herein on a social networking site or other type of hosted environment, then the player's computer would cooperate with the social networking server in order to present the game to the player. The player's computer would perform the instructions necessary to display the game while the remote server can determine the results (e.g., the final arrangement) and communicate this result via the Internet to the player's computer so that the player's computer can accurately display the result. The remote server may track and account for all credits wagered and won/lost while the player's computer can display the amount of credits owned or won at the direction of the remote server so the player cannot tamper with these amounts. All games described herein are considered to be played on the site described herein.

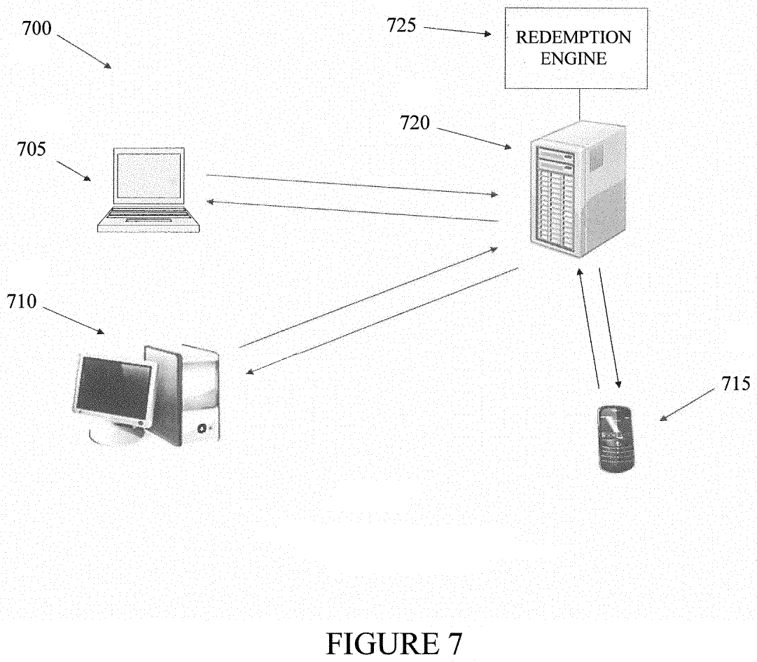

FIG. 7 is a block diagram illustrating another network structure, according to an embodiment.

FIG. 7 shows a system 700 according to the embodiments of the present invention. User (player) devices such as laptop computers 705, desktop computers 710 and smart phones 715 connect users to an Internet server 720 (same as game server 514) maintaining, or in communication with, a redemption engine 725. The connection between the user devices 705, 710 and 715 (same as 511, 512, 513) and Internet server 720 may be wired or wireless. The system 700 may also include routers and other conventional components which facilitate operation of the Internet.

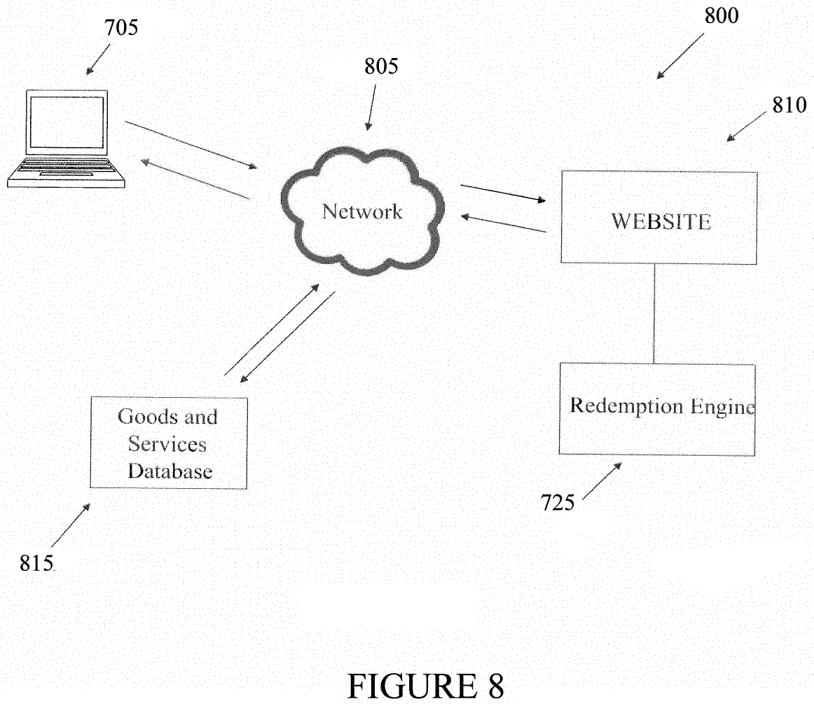

FIG. 8 is a block diagram of a system architecture of a website, according to an embodiment.

The system architecture comprises a user (or player) device 705, network 805, website 810 in communication with the redemption engine 725. As shown in FIG. 7, the Internet server 720 may maintain/administer the redemption engine 725.

Alternatively, the redemption engine 725 may be maintained by one or more separate servers or similar computer devices in communication with the Internet server 720. The redemption engine 725 maintains or communicates with a tangible goods and services library or database 815. The communication between the redemption engine 725 and database 815 may be direct or, as shown in FIG. 8, via the network 805.

In an embodiment, the redemption engine 725 is configured to redeem virtual currency for a tangible product (tangible goods and/or services). Tangible goods and services can be, for example, a new television, car, magazine subscription, meal at a restaurant, a flight, a software program, etc. The tangible goods and services can be delivered using any known mechanism, such as physical deliver via courier, electronic delivery via email (an email can be sent to the user which contains a link which when clicked provides the goods/services such as a coupon that can be used at an online retailer), etc. Wherever “virtual currency” is used herein with regard to redeeming virtual currency, this can also be substituted for other quantities described herein such as credits, loyalty points, etc. Any of these quantities (credits, loyalty points, virtual currency, or any other quantity/value described herein) can be redeemed for tangible goods/services in the same manner. The system designers would configure the system to allow for redemption of whichever quantities they choose (e.g., one game may allow only redemption of credits while another game may allow only redemption of loyalty points, etc.)

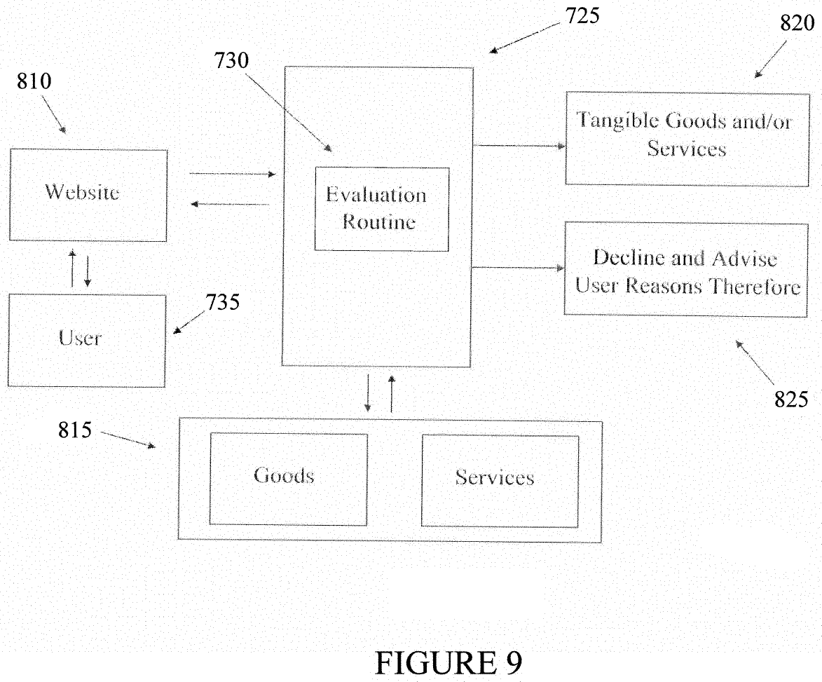

FIG. 9 is a block diagram of a redemption engine, according to an embodiment.

The redemption engine 725 comprises an evaluation routine 730 which evaluates the requesting user's play data including amount of virtual currency and related parameters as detailed below. The evaluation routine 730 receives the play data from the subject website 810 maintained by Internet server 720 responsive to a request by a user (also referred to as player) 735. The user 735 may make the request via the website 810 or directly to a separate dedicated redemption website. Responsive to the evaluation routine 730 determining that the user is eligible for tangible goods and/or services, the redemption engine 725 communicates with the goods and services database 815 to identify and present to the user available goods and/or services and corresponding amounts of virtual currency redeemable for each of said goods and/or services 820. Should the evaluation routine 730 determine that the user is not eligible for tangible goods and/or services, the redemption engine causes the user 735 to be notified of the decline and reasons therefore 825.

In one embodiment, tangible goods and/or services can be provided by the game server that maintains the website 810 that enables players to play the game. In another embodiment, tangible goods and/or services are purchased from third parties indirectly through the operator of the online business and website 810 (e.g., social networking games) through which the user earned the virtual currency. Alternatively, the goods and/or services may be significantly reduced in price or provided free by third parties in return for advertising, sponsorship or similar promotions on the operator's websites.

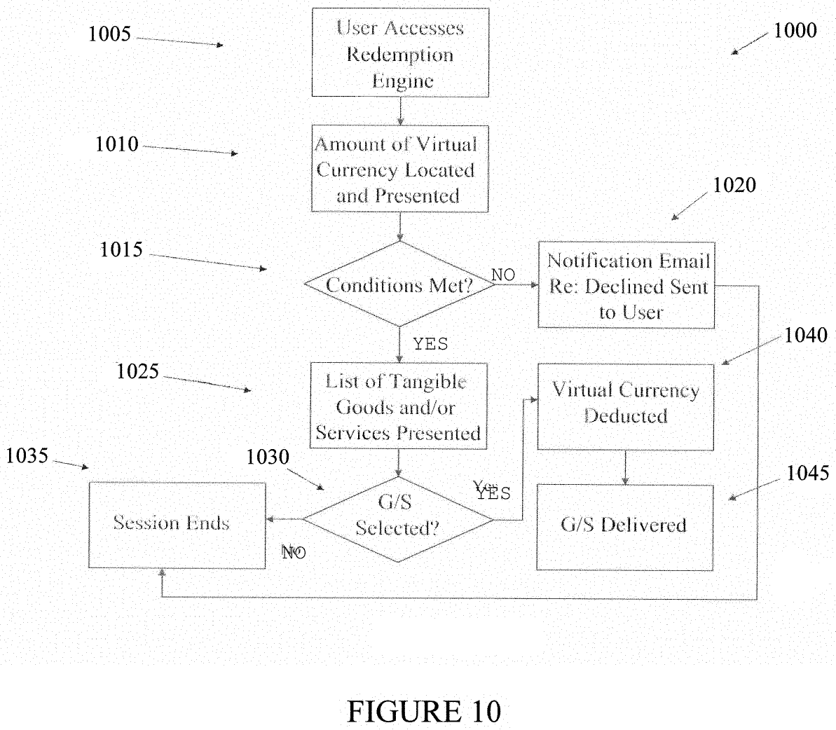

FIG. 10 is a flowchart illustrating an exemplary method of implementing a redemption engine, according to an embodiment.

In this example, the website is a gaming website on which users are able to earn virtual currency based on play. In operation 1005, a user having earned virtual currency from gaming, accesses a redemption engine via the gaming website or another dedicated website acting as a redemption gateway. In operation 1010, responsive to the user inputting security information (e. g., username and password), the redemption engine locates the amount of virtual currency earned by the user on the gaming website. In one embodiment as detailed above, the redemption engine retrieves the virtual currency amount from the gaming website (i.e., Internet server 720). Besides virtual currency amounts, in order to be eligible for redemption, the user may need to meet other conditions as well. For example, the user may need to have played the game a minimum number of hours, spent a minimum amount of actual money on the gaming website, referred a minimum number of other users, accomplished a certain number of game tasks, etc. It is envisioned that different goods and/or services may require different conditions to be met. Those skilled in the art will recognize that any number of conditions may be required prior to a user becoming eligible for the redemption.

In operation 1015, it is determined whether the amount of virtual currency meets a minimum threshold and/or any other conditions, if any, are met. Condition(s) can be placed on whether the user would currently be allowed to redeem their virtual currency (or credits, points, etc.) for tangible goods and/or services. For example, any number/combination of the following conditions can be required: a) that the user has a predetermined number of virtual currency (or credits, points, etc.); b) that the user has referred a predetermined number of friends who have registered with the game currently being utilized; c) that the user has played a predetermined number of games (e.g., 50); d) that the user has played the game a predetermined number of hours (e.g., at least 5); e) that the user has completed a particular task in the game (e.g., kill a particular monster, building a particular building, received a particular slot machine symbol combination, etc.); f) that the user has beaten a predetermined number of other players (e.g., 5) in an inter-player competition in the game; g) that the user has spent a predetermined amount of his/her real cash (e.g., at least $10) on items in the game; h) that the user has achieved at least a predetermined score in the game (e.g., 500 points, where points are awarded for completing individual tasks); i) that the user has upgraded his/her account on the game to a premium account type (which typically would cost cash). Any of the ways described herein that a player can earn loyalty points can also be used as one or more of the conditions required before the player can redeem and of his/her points for tangible product(s).

If in operation 1015 it is determined that the conditions are not met, then the method proceeds to operation 1020 wherein a notification is presented to the user indicating that the user is not eligible and explaining the reasons (e.g., not enough virtual currency earned).

If the minimum virtual currency amount and/or other conditions, if any, are met in operation 1015, then the method proceeds to operation 1025 wherein the user is presented a list of tangible goods and/or services available and the corresponding amount of virtual currency redeemable for each. The required virtual currency amounts are established by the gaming website operator. In operation 1030, it is determined if the user selects tangible goods and/or services. If the user does not select tangible goods and/or services, then the method proceeds to operation 1035 upon which the redemption session ends. If in operation 1030 the user selects tangible goods and services (the user/player confirms that he/she does want to proceed to make the conversion of virtual currency to at least one tangible product selected by the user), then the method proceeds to operation 1040 wherein the required virtual currency is deducted from the user's account associated with the gaming website. In operation 1045, the goods and/or services are shipped or otherwise delivered to the user (e.g., delivered electronically, delivered physically in the mail, etc.) It should be understood that the order of the operations of the flowchart illustrated in FIG. 10 are exemplary and may be altered as needed.

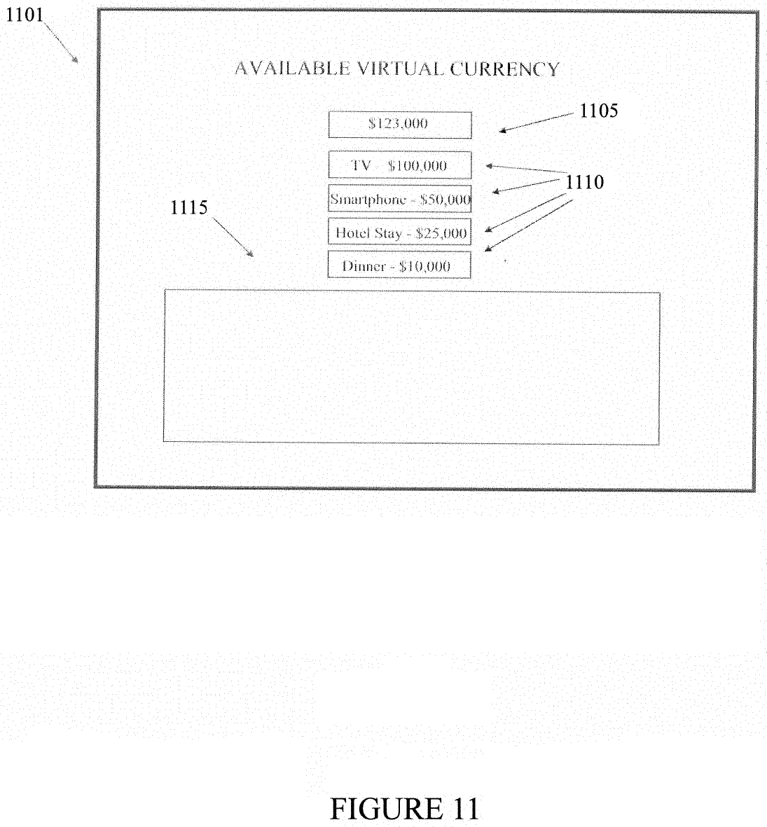

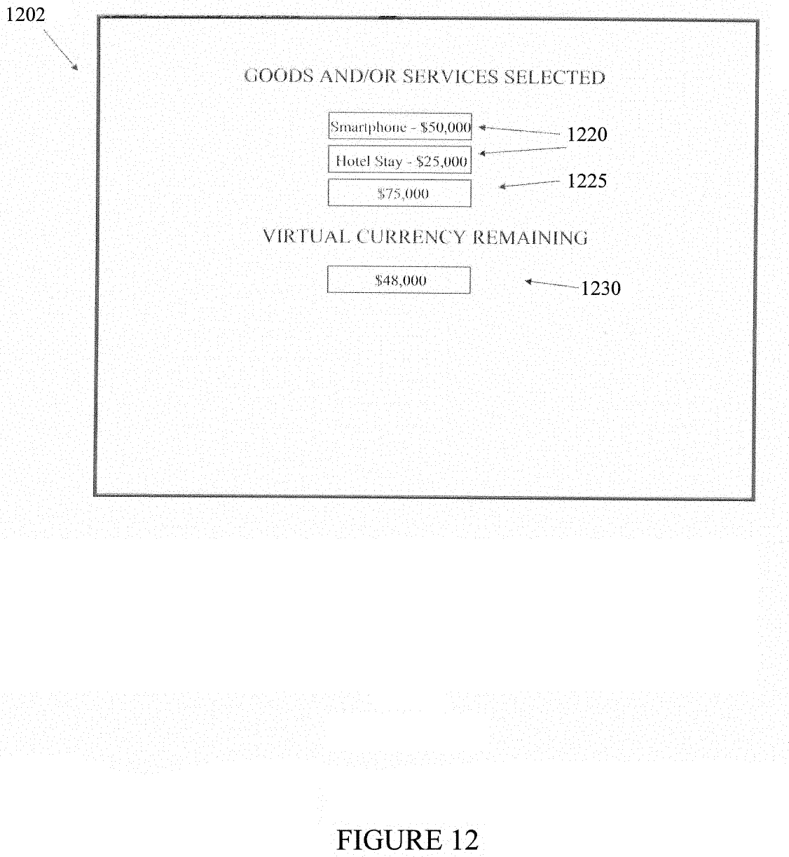

FIGS. 11-12 are drawings of a first web page and a second subsequent web page, both illustrating redemption of credits, according to an embodiment.

FIG. 11 shows a webpage 1101 depicting an amount of virtual currency 1105 (or credits, points, etc.) available to the player and goods and/or services 1110. The webpage may also depict advertisements 1115 which may be related to the providers of the tangible goods and/or services.

FIG. 12 shows a webpage 1202 depicting tangible goods and/or services selected 1220 (an itemized list) and a total amount of virtual currency spent 1225 and remaining 1230.

In another embodiment, the system includes a dynamically adjusts the rate at which virtual currency is earned and amounts of virtual currency required to be redeemed for tangible goods/services on a per customer or player basis. The dynamic adjustments by the system may be based on any number of parameters. For example, relative to virtual currency being earned via gaming activities, the parameters may include: (i) frequency of play; (ii) amounts played; (iii) number of friends referred; (iv) successive days played; and (v) pattern of play. Those skilled in the art will recognize that any conceivable parameters may be utilized to dynamically adjust the rate at which virtual currency is earned and redemption amounts of virtual currency required to acquire tangible goods/services. In an exemplary example, the system may offer a first player a dinner for 50,000 units of virtual currency (or credits, loyalty points, etc.) while a second player may be offered the same dinner for 30,000 units of virtual currency (or credits, loyalty points, etc.). For example, a second player may have more loyalty points than a first player (e.g., the second player is perceived by the game/system to be more valuable than the first player) so a price for the same tangible product would cost the second player less than the first player. In other words, the second player gets a discount on the cost of redeeming points for tangible goods and/or services because the second player is more valuable to the game than the first player (measured using any metric described herein).

In another embodiment, the system may use a rate of 0.5 point per activity (e.g., hand played) for a first player and a rate of 1 point per activity for a second player. The distinctions in the rate at which virtual currency is earned and amounts of virtual currency required to be redeemed for tangible goods/services being premised on the parameters of play, as measured by the operator, being more significant or meaningful for the second player than the first player. The dynamic alterations may take place constantly or at pre-established time intervals. The difference in points earned per player can be based on a player's amount of loyalty points. For example a first player who has 100 loyalty points and a second player who has 150 loyalty points. The second player would earn points (e.g., credits, virtual currency, further loyalty points, or any quantity) based on their amount of loyalty points (or any other quantity described herein). Thus, the first player can earn 0.5 points per activity (e.g., a spin on a slot machine) while the second player can earn 1 point per activity (e.g., a spin on the slot machine), wherein the points earned can be loyalty points, credits, or any other quantity described herein.

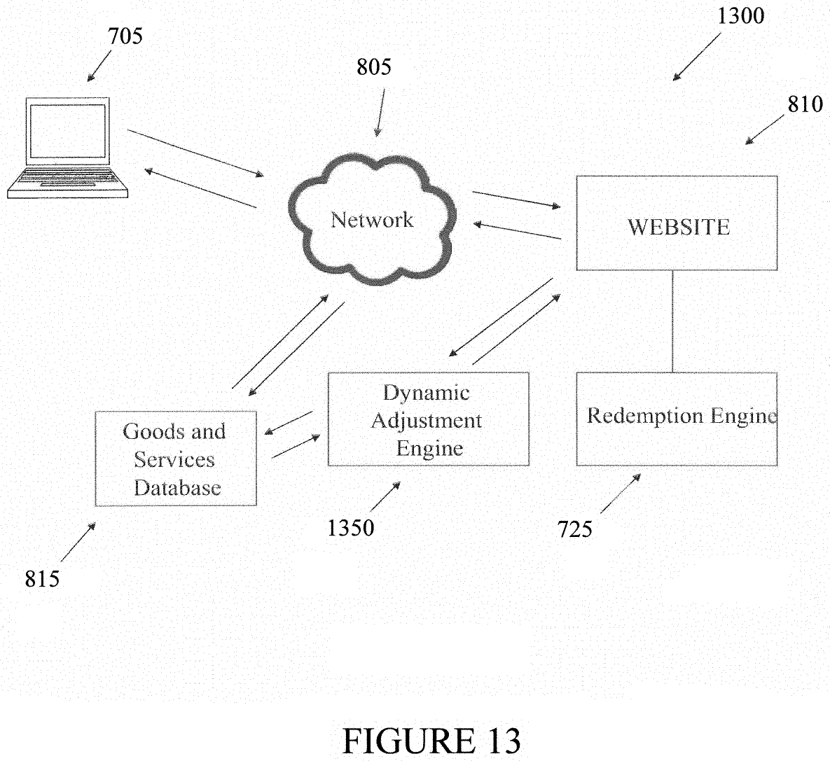

FIG. 13 is another block diagram of a system architecture of a website, according to an embodiment.

The system architecture comprises a user device 705, network 805, website 810 in communication with the redemption engine 725. The redemption engine 725 maintains or communicates with a tangible goods and services library or database 815. A dynamic adjustment engine 1350 communicates with at least the website 810 to monitor parameters of play, and tangible goods and services library or database 815 to adjust redemption amounts. In this embodiment, the tangible goods and services library or database 815 is configured with sub-groups on a per player basis.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All features described herein (including all documents incorporated by reference) can be combined with one another without limitation. While the “credits” are used herein to refer to awards provided to players typically refers to non-cash value credits, this can also refer to cash credits as well (that are directly redeemable for cash).

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. A method to implement a game, the method comprising:
providing a server and executing on an electronic processing unit on the server instructions that enable a plurality of computing devices each with a respective player to communicate with the server and to cause for each of the computing devices:
maintaining an amount of credits earned by a player in a player's account and periodically providing the player a quantity of free credits, wherein the credits are non-cash value credits;
enabling the player to purchase credits using cash, wherein the player is offered to purchase a plurality of different amounts of credits with at least one of the different amounts also comprising loyalty points;
enabling the player to play a slot machine game by receiving a cost in credits to play the slot machine game and awarding credits upon winning the game, wherein loyalty points are awarded to the player when the player advances a level in the game but valuable awards are not awarded based on random results in the game;
determining whether the player has a minimum threshold amount of loyalty points in order to display a list of potential tangible items, wherein the determining determines that the player has the minimum threshold amount of loyalty points;
retrieving the list of potential tangible items from a separate goods/services database, displaying the list of potential tangible items, and receiving a selection from the player of a tangible item out of the list of potential tangible items,
determining whether the player meets one or more conditions to be eligible to convert the loyalty points into the tangible item, wherein the determining determines that the player is eligible;
deducting a cost of the tangible item in loyalty points from the player; and
delivering the tangible item to the player,
wherein the credits are not redeemable by the player for cash.

2-4. (canceled)

5. The method as recited in claim 1, wherein the tangible item is sold directly by a party who maintains the game.

6. The method as recited in claim 1, wherein the tangible item is sold by a third party that has a relationship with a party who maintains the game.

7. The method as recited in claim 1, wherein the tangible item is delivered to the player physically.

8. The method as recited in claim 1, wherein the tangible item is delivered electronically as a coupon.

9. (canceled)

10. The method as recited in claim 1, wherein the one or more conditions comprise that the player has referred at least a predetermined number of friends.

11. The method as recited in claim 1, wherein the one or more conditions comprise that the player has completed a particular task in the game.

12. The method as recited in claim 1, wherein the one or more conditions comprise that the player has spent at least a predetermined amount of real cash in the game.

13. The method as recited in claim 1, wherein the cost of the tangible item will vary between a first player and a second player, wherein the first player has different amount of loyalty points than the second player has.

14. The method as recited in claim 1, wherein a rate the player is awarded loyalty points is based on an amount of loyalty points the player has.

15. The method as recited in claim 14, wherein a first player has A loyalty points and a second player has B loyalty points, A>B, and the first player is awarded loyalty points per game activity at a faster rate than the second player is awarded loyalty points per game activity.

16. An apparatus to implement a game, the apparatus comprising:
a network connection;
a server connected to the network connection, the server configured to read and execute computer readable instructions stored on a computer readable storage, the instructions programmed to cause the server to communicate with a plurality of computing devices each with a respective player and cause each of the plurality of computing devices to:
maintain an amount of credits earned by a player in a player's account and periodically provide the player a quantity of free credits, wherein the credits are non-cash value credits;
enable the player to purchase credits using cash, wherein the player is offered to purchase a plurality of different amounts of credits with at least one of the different amounts also comprising loyalty points;
enable the player to play a game, each game costing the player credits to play and awards credits to the player upon winning, wherein loyalty points are awarded to the player when the player advances a level in the game but valuable awards are not awarded based on random results in the game;
determine whether the player has a minimum threshold amount of loyalty points in order to display a list of potential tangible items, wherein only when the player has the minimum threshold amount of loyalty points then retrieve the list of potential tangible items from a separate goods/services database, and display the list of potential tangible items to the player, and receive a selection from the player of a tangible item out of the list of potential tangible items, and when the player does not have the minimum threshold amount of loyalty points then the player is notified that the player is not eligible and the player cannot convert loyalty points into a tangible item;
determine whether the player meets one or more conditions to be eligible to convert loyalty points into a tangible item; and
when the player meets the one or more conditions, then: deduct a cost in loyalty points of the tangible item from the player's account and initiate a delivery of the tangible item to the player,
wherein the credits are not redeemable by the player for cash.

17-19. (canceled)

20. The apparatus as recited in claim 16, wherein the instructions are further programmed such that the tangible item is sold directly by a party who maintains the game.

21. The apparatus as recited in claim 16, wherein the instructions are further programmed such that the tangible item is sold by a third party that has a relationship with a party who maintains the game.

22. The apparatus as recited in claim 16, wherein the instructions are further programmed such that the tangible item is delivered to the player physically.

23. The apparatus as recited in claim 16, wherein the instructions are further programmed such that the tangible item is delivered electronically as a coupon.

24. (canceled)

25. The apparatus as recited in claim 16, wherein the instructions are further programmed such that the one or more conditions comprise that the player has referred at least a predetermined number of friends.

26. The apparatus as recited in claim 16, wherein the instructions are further programmed such that the one or more conditions comprise that the player has completed a particular task in the game.

27. The apparatus as recited in claim 16, wherein the instructions are further programmed such that the one or more conditions comprise that the player has spent at least a predetermined amount of real cash in the game.

28. The apparatus as recited in claim 16, wherein the instructions are further programmed such that the cost of the tangible item will vary between a first player and a second player, wherein the first player has different amount of loyalty points than the second player has.

29. The apparatus as recited in claim 16, wherein the instructions are further programmed such that a rate the player is awarded the loyalty points is based on an amount of loyalty points the player has.

30. The apparatus as recited in claim 29, wherein the instructions are further programmed such that a first player has A loyalty points and a second player has B loyalty points, A>B, and the first player earns loyalty points per game activity at a faster rate than the second player earns loyalty points per game activity.

31. The method as recited in claim 1, wherein the executing further performs offering the player a limited quantity of free credits.

32. The apparatus as recited in claim 16, wherein the instructions are further programmed to offer the player a limited quantity of free credits.
